(19) United States
(12) Patent Application Publication
(10) Pub. No.: US 2017/0108962 A1
(43) Pub. Date: Apr. 20, 2017

(54) CAPACITIVE WHITEBOARD ERASER

(71) Applicant: WALTOP INTERNATIONAL CORPORATION, Hsinchu City (TW)

(72) Inventors: YING HWA TANG, Hsinchu City (TW); YI CHIH CHANG, Hsinchu City (TW)

(21) Appl. No.: 14/945,226

(22) Filed: Nov. 18, 2015

(30) Foreign Application Priority Data
Oct. 19, 2015 (TW) 104216703

(51) Int. Cl. G06F 3/044

(52) U.S. Cl. CPC G06F 3/044

(57) ABSTRACT

A capacitive whiteboard eraser is disclosed. The capacitive whiteboard eraser includes an eraser body, a control circuit board, an emitting electrode and a tact switch. The eraser body is for a user to hold the capacitive whiteboard eraser with hand. The control circuit board is disposed in the eraser body and configured to generate an erasing control signal. The emitter electrode is disposed on a housing of the eraser body, electrically connected with the control circuit board, and configured to transmit the erasing control signal. The tact switch is dispose on the control circuit board, and when the tact switch is turned on, the control circuit board correspondingly generates and transmits the erasing control signal to the emitting electrode, in order to transmit the erasing control signal to a capacitive whiteboard for performing an erasing procedure.

### CLAIM OF PRIORITY

The present application claims priority from Taiwan Application No. 104216703, filed on Oct. 19, 2015 and entitled “CAPACITIVE WHITEBOARD ERASER”, the contents of which are expressly incorporated herein by reference in their entirety.

### BACKGROUND OF THE INVENTION

1. Field of the Invention

The present invention generally relates to a capacitive whiteboard eraser, and particularly relates to a capacitive whiteboard eraser capable of erasing the writing inputted on a capacitive whiteboard immediately.

2. Description of Related Art

A conventional electric whiteboard is a whiteboard having a scanner so the conventional electric whiteboard can roll the writing surface to the backside of the conventional electric whiteboard for scanning. Therefore, the information written on the writing surface, for example words, drawings, or the writing written by ink, is printed by a printer or stored in a memory. Because the scanner is applied in the conventional electric whiteboard to scan the writing written on the writing surface by ink, it has no need of orientating the conventional whiteboard pen and the conventional whiteboard eraser or of finding the positions of the conventional whiteboard pen and the conventional whiteboard eraser. Therefore, the conventional whiteboard pen and the conventional whiteboard eraser applied to the common whiteboard (not electric whiteboard) also can apply to the conventional electric whiteboard for writing and erasing. In other words, the conventional whiteboard pen, which can outputs ink to write, can be used to write on the conventional electric whiteboard directly, and the conventional whiteboard eraser, which only can erase the writing written by ink, can be used to erase the writing written on the conventional electric whiteboard can be erased directly. The information written on the conventional electric whiteboard by ink is scanned, printed or stored only by the scanner so the conventional whiteboard pen and the conventional whiteboard eraser are not involved in the scanning, printing or storing. Therefore, the user can use the conventional whiteboard pen and the conventional whiteboard eraser to write and erase on the conventional electric whiteboard directly.

However, with the trend that the touching sensing technique is applied to the electric whiteboard largely, therefore, the electric whiteboard is developed to be a capacitive whiteboard capable of inputting the writing (or information), into the capacitive whiteboard by the capacitive induction simultaneously for converting the information to digital information to be stored when the writing (or information) is written thereon with a capacitive stylus. However, because the conventional whiteboard eraser cannot emit the signals, the capacitive whiteboard cannot record the positions and the moving trace of the conventional whiteboard eraser to define an erasing area for erasing the writing inputted by the capacitive induction. Accordingly, the conventional whiteboard eraser cannot be applied to the capacitive whiteboard.

Therefore, in view of foregoing drawbacks of conventional whiteboard eraser, there is a need to provide a capacitive whiteboard eraser capable of being applied to the capacitive whiteboard and capable of erasing the writing inputted by the capacitive stylus.

### SUMMARY OF THE INVENTION

In view of the foregoing, it is an object of embodiments of the present invention to provide a capacitive whiteboard eraser capable of being applied to the capacitive electrical whiteboard and capable of erasing the writing inputted by the capacitive stylus. Further, the capacitive whiteboard eraser can move toward any sides of the capacitive whiteboard eraser to erase on the capacitive whiteboard but the capacitive whiteboard does not define a wrong erasing area. Even the capacitive whiteboard eraser rotates to erase on the capacitive whiteboard, the capacitive whiteboard does not define a wrong erasing area.

According to the object, one embodiment of the present invention provides a capacitive whiteboard eraser. The capacitive whiteboard eraser includes an eraser body, a control circuit board, an emitting electrode and a tact switch. The eraser body is for a user to hold the capacitive whiteboard eraser with hand. The control circuit board is disposed in the eraser body and configured to generate an erasing control signal. The emitter electrode is disposed on a housing of the eraser body, electrically connected with the control circuit board, and configured to transmit the erasing control signal. The tact switch is disposed on the control circuit board, and when the tact switch is turned on, the control circuit board correspondingly generates and transmits the erasing control signal to the emitting electrode, in order to transmit the erasing control signal to a capacitive whiteboard for performing an erasing procedure.

### BRIEF DESCRIPTION OF THE DRAWINGS

FIG. 1 is a top view diagram illustrating a capacitive whiteboard eraser according to one embodiment of the invention.

FIG. 2 is a side view diagram illustrating a capacitive whiteboard eraser according to one embodiment of the invention.

FIG. 3 is a cross-sectional view diagram illustrating a capacitive whiteboard eraser according to one embodiment of the invention.

FIG. 4A is exploded diagram illustrating a capacitive whiteboard eraser according to one embodiment of the present invention.

FIG.4B is a top view diagram illustrating the triggering member of the capacitive whiteboard eraser according to one embodiment of the present invention.

FIG. 4C is a perspective form diagram illustrating the triggering member of the capacitive whiteboard eraser according to one embodiment of the present invention.

FIG. 5 is a cross-sectional view diagram illustrating a capacitive whiteboard eraser, according to one embodiment of the invention.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the scale of each component may not be expressly exactly.

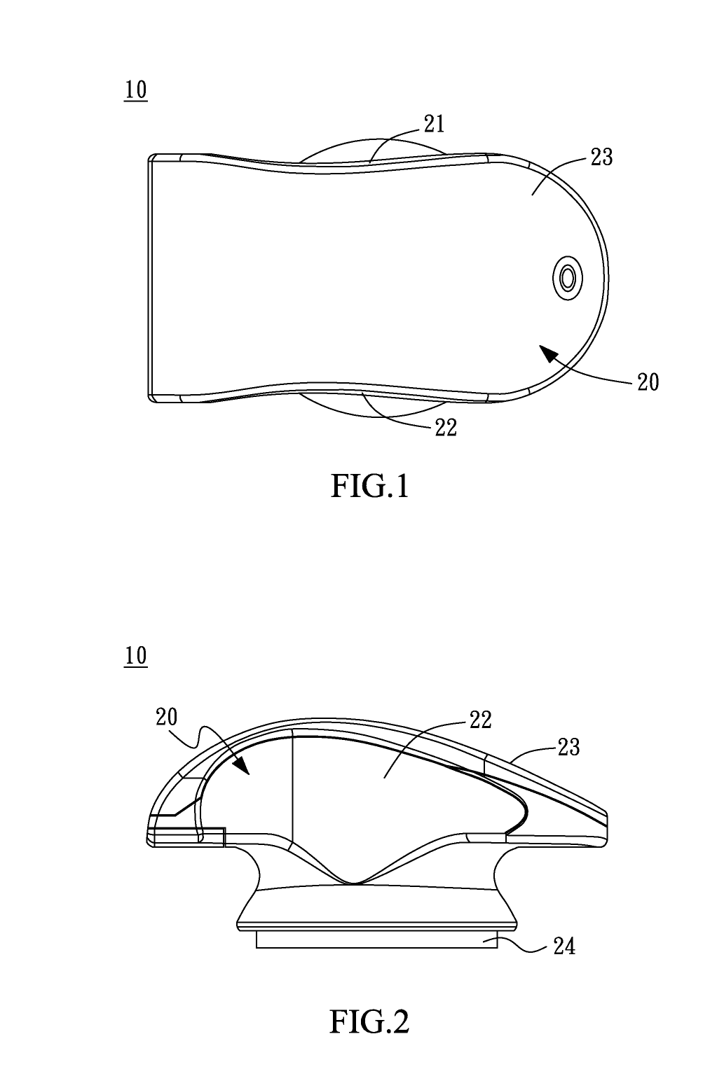

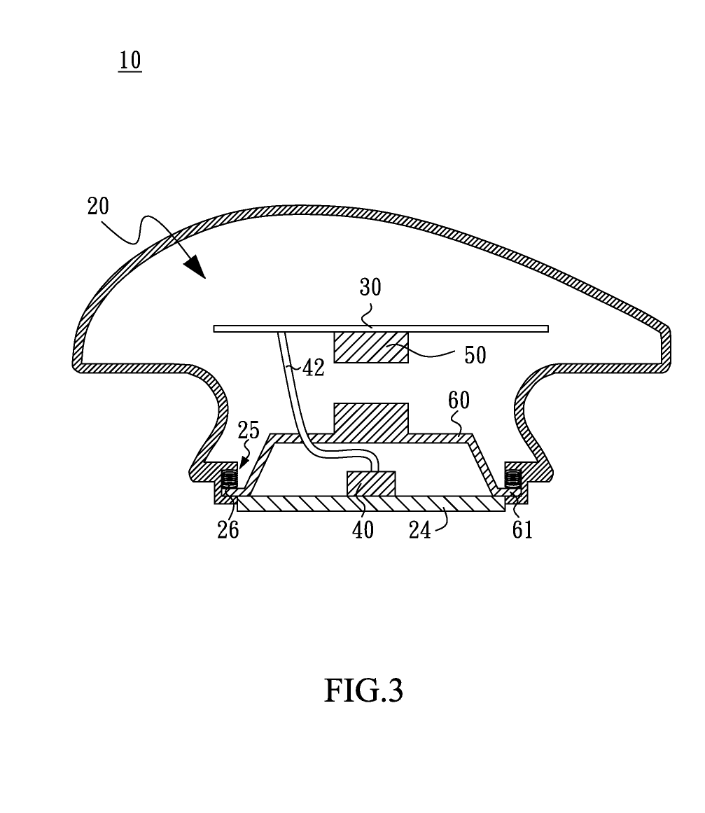

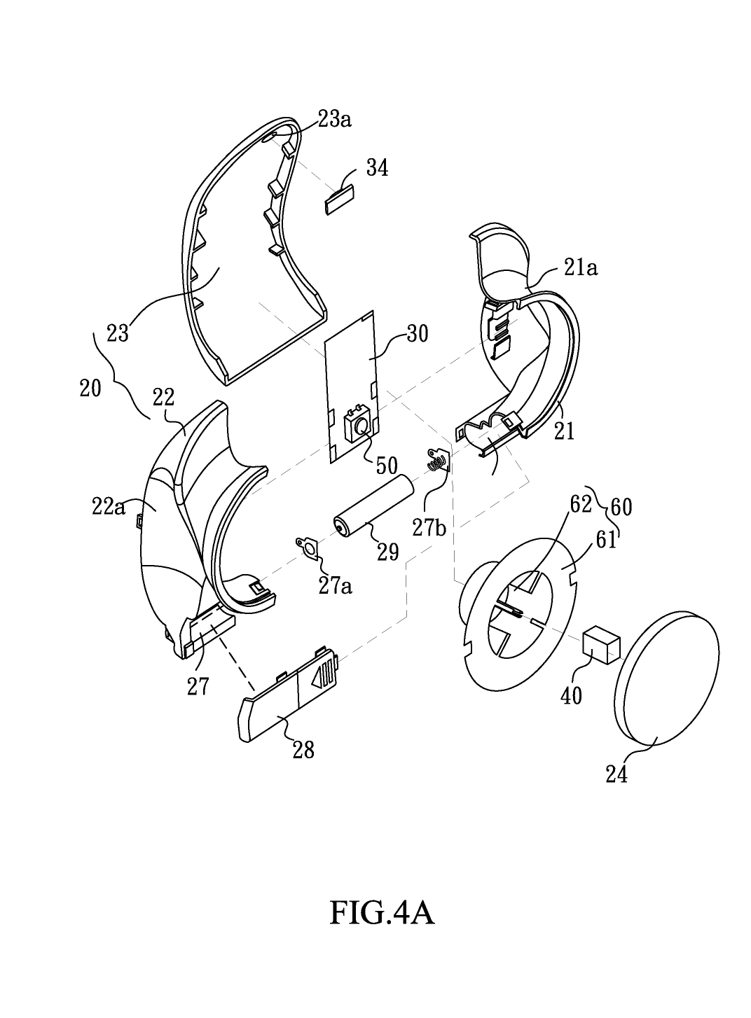

Referring to FIG. 1, FIG. 2 and FIG. 3, FIG. 1, FIG. 2 and FIG. 3 are a top view diagram, a side view diagram, and a cross-sectional view diagram respectively illustrating a capacitive whiteboard eraser in accordance with one embodiment of the present invention. As shown in figures, a capacitive whiteboard eraser 10 includes an eraser body 20, a control circuit board 30, an emitting electrode 40 and a tact switch 50. The eraser body 20 is for the user to hold the capacitive whiteboard eraser 10 with hand. The control circuit board 30 is disposed in the eraser body 20, and configured to generate an erasing control signal. The emitting electrode 40 is disposed on a housing of the eraser body 20, electrically connected with control circuit board 30 and configured to transmit the erasing control signal. The tact switch 50 is disposed on the control circuit board 30, and when the tact switch 50 is turned on, the control circuit board 30 correspondingly generates and transmits the erasing control signal to the emitting electrode 40, in order to transmit the erasing control signal to a capacitive whiteboard for performing an erasing procedure.

Further, in this embodiment, the emitting electrode 40 may further include a connecting member 42. Two ends of the connecting member 42 are respectively connected with the emitting electrode 40 and the control circuit board 30, and the connecting member 42 may include a conductive material, such that the emitting electrode 40 can be electrically connected with the control circuit board 30 by the connecting member 42.

Referring to FIG. 3, the capacitive whiteboard eraser 10 may further include a triggering member 60. When the capacitive whiteboard eraser 10 erases on the electrical whiteboard, the triggering member 60 electrically contacts the tact switch, so as to turn on the tact switch 50. However, in this embodiment, the emitting electrode 40 is disposed on the bottom housing 24 of the eraser body 20, and the tact switch 50 is disposed on a bottom side of the control circuit board 30, and the triggering member 60 is disposed on a top side of the bottom housing 24 and facing the tact switch 50. Thus, when the capacitive whiteboard eraser 10 erases on the electrical whiteboard, the bottom housing 24 is pressed by the electrical whiteboard so that the triggering member 60 is correspondingly driven, to move towards an inside of the eraser body 20, and therefore the triggering member 60 and the tact switch 50 are electrically connected with each other to turn on the tact switch 50. Then, the control circuit board 30 is correspondingly switched on to generate the erasing control signal, and the control circuit board 30 transmits the erasing control signal to the emitting electrode 40 for emitting the erasing control signal to the electrical whiteboard for proceeding the erasing procedure.

When the electrical whiteboard senses and receives the erasing control signal, the electrical whiteboard will record the positions and the moving trace of the capacitive whiteboard eraser 10. Then, the electrical whiteboard defines the position where the according to the erasing control signal as the center of the erasing area and defines a predetermined distance to be the diameter or radius of the erasing area for forming a circular erasing area. The writing (or information) written in the circular erasing area by the capacitive stylus is erased by the electrical whiteboard eraser 10.

On the other hand, when the capacitive whiteboard eraser 10 moves away from the electrical whiteboard, the bottom housing 24 causes the triggering member 60 to be reset to the original position, so that the triggering member 60 will be not electrically connected with the tact switch 50 in order to turn off the tact switch 50, and the control circuit board 30 will accordingly stop generating and transmitting the erasing control signal to the emitting electrode 40. Therefore, the emitting electrode 40 will stop emitting the erasing control signals to the electrical whiteboard so as to quit the erasing procedure. Moreover, when the electrical whiteboard does not receive the erasing control signal, the electrical whiteboard will also stop recording the positions and the moving trace of the capacitive whiteboard eraser 10.

More particularly, in this embodiment, the left side housing 21 and the right side housing 22 of the eraser body 20 can be combined with each other to form a slot 25, and a connecting part 61 of the triggering member 60 is disposed in the slot 25. Further, the eraser body 20 may include a resetting member 26, which is disposed in the slot 25. More specifically speaking, the resetting member 26 is disposed between the connecting part 61 of the triggering member 60 and a side wall of the slot 25. In one embodiment, the resetting member 26 can be a spring or an elastic piece. Thus, when the capacitive whiteboard eraser 10 moves away from the electrical whiteboard, the bottom housing 24 may cause the triggering member 60 to be reset to the original position by the resetting member 26, so as to ensure that the triggering member 60 and the tact switch 50 are separated with each other for efficiently avoid generating error signals and achieving the effect of energy saving.

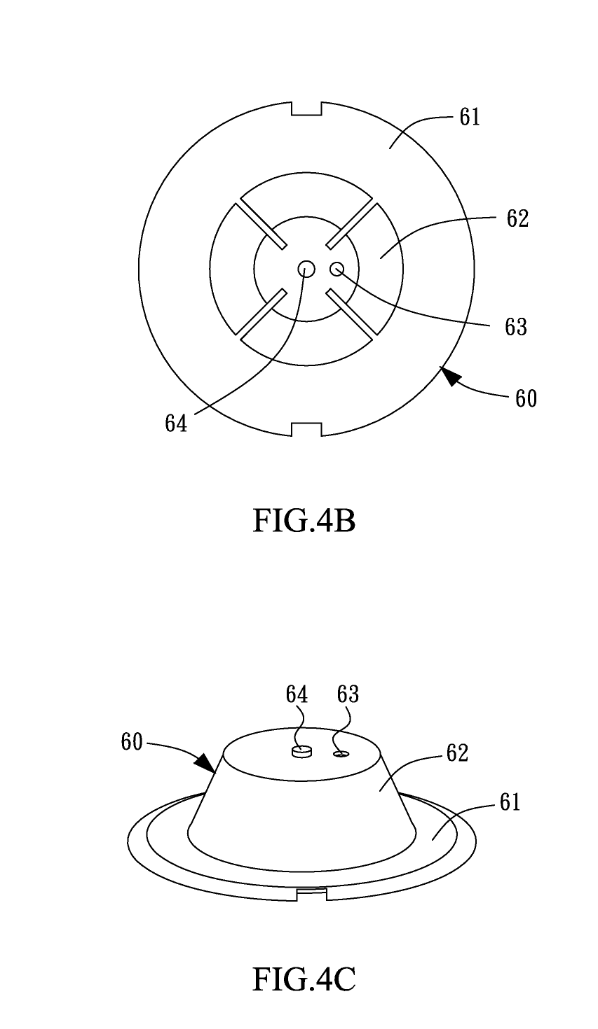

Referring to FIG.4A, FIG. 4A is exploded diagram illustrating a capacitive whiteboard eraser in accordance with one embodiment of the present invention. As shown in figure, the eraser body 20 includes a left side housing 21, a right side housing 22, a top housing 23 and a bottom housing 24. In this embodiment, although the left side housing 21, the right side housing 22, the top housing 23 and the bottom housing 24 can be disassembled to be four independent housing, but in another embodiment, any two or three housings of the left side housing 21, the right side housing 22, the top housing 23 and the bottom housing 24 are integrated as one member (or housing), for example the left side housing 21 and the right side housing 22 are integrated as one member (or housing) or the left side housing 21, the right side housing 22 and the top housing 23 are integrated as one member (or housing).

Both of the left side housing 21 and the right side housing 22 have a holding member 21a, 22a respectively disposed outside the left side housing 21 and the right side housing 22 for the user to conveniently take and use the capacitive whiteboard eraser 10 with hand. In this embodiment, the holding member 21a and 22a are the concaves which are respectively sunken toward the inner of the left side housing 21 and the right side housing 22 for the user to hold with hand conveniently. The bottom housing 24 has a circular bottom 25, and the triggering member 60 may include an accommodating cavity 62 for accommodating the emitting electrode 40, and the accommodating cavity 62 is in the center area of the bottom housing 24. More specifically, the accommodating cavity 62 is a circular cavity for holding emitting electrode 40 therein. The emitting electrode 40 is disposed at the center region of the accommodating cavity 62 (the center of the circle of the holding cavity 26), which corresponds to the center of the circular bottom housing 24 (the center of the circle of the bottom housing 24). In another embodiment, the accommodating cavity can be fabricated in various shapes according to the demand and the design, and the emitting electrode is disposed in the accommodating cavity to correspond to the center of the bottom housing.

Referring to FIG.4B and FIG.4C, FIG.4B and

FIG.4C are a top view diagram and a perspective form diagram respectively illustrating the triggering member of the capacitive whiteboard eraser in accordance with one embodiment of the present invention. The top part of the accommodating cavity 62 has a hole 63, and the connecting member 42 of the emitting electrode 40 is set through the hole 63 to be connected with control circuit board 30. Furthermore, the top part of the accommodating cavity 62 has a convex member 64, which is a protrusion sunken upward. It means that the convex member 64 is a protrusion sunken toward the inner of the capacitive whiteboard eraser 10 and is configured to contact and turn on the tact switch 50.

Referring to FIG.4A, the eraser body 20 may have a battery container 27, and the battery container 27 is for putting a battery 29 the battery container 27 to be a power supply of the capacitive whiteboard eraser 10. The battery container 27 has a positive contact 27a for contacting with the positive electrode of the battery 27 and a negative contact 27b for contacting with the negative electrode of the battery 27. Therefore, the electric energy or power of the battery 29 is outputted to the capacitive whiteboard eraser 10. Furthermore, the eraser body 20 has a battery cover 28 for sealing the battery 29 in the battery container 27 and for changing the battery 29.

In addition, a low power indicator 34 is disposed on the top housing 23 or in the top housing 23 (or in the eraser body 20) for giving an alarm when the power of the battery 29 is low. When the detecting circuit disposed on the control board 30 detects that the voltage or the charge of the battery 29 is in low state, the detecting circuit notifies the low power indicator 34 to give an alarm for reminding the user to change the battery 29. By this way, when the capacitive whiteboard eraser 10 erases on the electrical whiteboard, the situation that the capacitive whiteboard eraser 10 is unable to emit the control signals by low voltage or low charge of the battery can be avoided. And the situation that the writing (or information) inputted by the capacitive stylus cannot be erased by the capacitive whiteboard eraser 10 caused by low voltage or low charge of the battery also can be avoided. The low power indicator 34 is a LED or other indicator capable of emitting light or voice. Referring to FIG. 2A, in this embodiment, although the low power indicator 34 is disposed in the eraser body 20 and the low power indicator 34 is observed through an opening or a transparent area 23a disposed on the top housing 23, but in another embodiment, the low power indicator is disposed directly on the top housing.

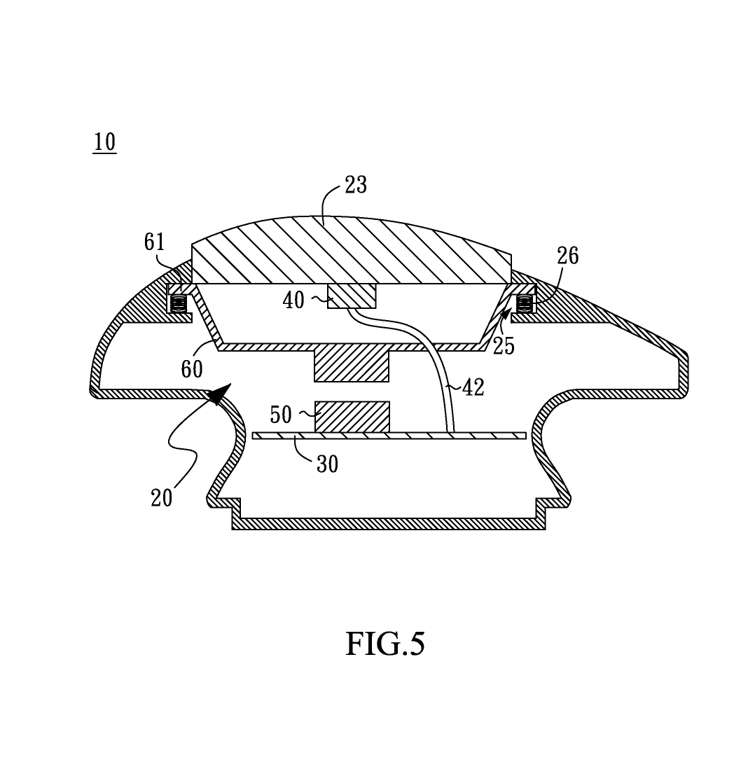

Referring to FIG. 5, FIG. 5 is a cross-sectional view diagram respectively illustrating a capacitive whiteboard eraser in accordance with another embodiment of the present invention. The emitting electrode 40 is disposed on a bottom side of the top housing 23, and the tact switch 50 is disposed on a top side of the control circuit board 30, and the triggering member 60 is disposed on the bottom side of the top housing 23 and facing the tact switch 50. Thus, when the capacitive whiteboard eraser 10 erases on the electrical whiteboard, the top housing 23 is pressed by the electrical whiteboard so that the triggering member 60 is correspondingly driven to move towards an inside of the eraser body 20, and therefore the triggering member 60 and the tact switch 50 are electrically connected with each other to turn on the tact switch 50. Then, the control circuit board 30 is correspondingly switched on to generate the erasing control signal, and the control circuit board 30 transmits the erasing control signal to the emitting electrode 40 for emitting the erasing control signal to the electrical whiteboard for proceeding the erasing procedure.

On the other hand, when the capacitive whiteboard eraser 10 moves away from the electrical whiteboard, the top housing 23 causes the triggering member 60 to be reset to the original position, so that the triggering member 60 will be not electrically connected with the tact switch 50 in order to turn off the tact switch 50, and the control circuit board 30 will accordingly stop generating and transmitting the erasing control signal to the emitting electrode 40. Therefore, the emitting electrode 40 will stop emitting the erasing control signals to the electrical whiteboard so as to quit the erasing procedure. Moreover, when the electrical whiteboard does not receive the erasing control signal, the electrical whiteboard will also stop recording the positions and the moving trace of the capacitive whiteboard eraser 10.

More particularly, in this embodiment, the left side housing 21 and the right side housing 22 of the eraser body 20 can be combined with each other to form a slot 25, and a connecting part 61 of the triggering member 60 is disposed in the slot 25. Further, the eraser body 20 may include a resetting member 26, which is disposed in the slot 25. More specifically speaking, the resetting member 26 is disposed between the connecting part 61 of the triggering member 60 and a side wall of the slot 25. In one embodiment, the resetting member 26 can be a spring or an elastic piece. Thus, when the capacitive whiteboard eraser 10 moves away from the electrical whiteboard, the top housing 23 may cause the triggering member 60 to be reset to the original position by the resetting member 26, so as to ensure that the triggering member 60 and the tact switch 50 are separated with each other for efficiently avoid generating error signals and achieving the effect of energy saving.

The capacitive whiteboard eraser utilizes an emitting electrode, which is disposed in the eraser body and corresponds to the center of the housing of the eraser body, to emit the control signals and the electrical whiteboard induces the sensing signals to calculate the position of the emitting electrode and to define an erasing area. The electrical whiteboard defines the position of the emitting electrode to be the center of the erasing area and adopt a predefined diameter or radius to be the diameter or the radius of the erasing area for forming a circular erasing area. Thus, the writing (or information) written by the stylus can be erased by the capacitive whiteboard eraser, and as the distances from the position of the mitting electrode to any point at the circumferences of the circular bottom are the same, the capacitive whiteboard eraser can moves freely on the electrical whiteboard toward any direction with any side of the electrical whiteboard. Therefore, it does not influence the judgments of the capacitive whiteboard or it does not result in the difficulty in defining an erasing area. Furthermore, because a low power indicator is deposed on the top housing or in the top housing of the capacitive whiteboard eraser, both of the situation that the capacitive whiteboard eraser 10 is unable to emit the control signals because of the low state of voltage or charge of the battery and the situation that the writing (or information) inputted by the stylus cannot be erased by the capacitive whiteboard eraser 10 because of the low state of voltage or charge of the battery can be avoided. Therefore, this invention provides provide a capacitive whiteboard eraser capable of being applied to the electrical whiteboard, erasing the writing inputted by the capacitive stylus, and having low power indicator.

Although specific embodiments have been illustrated and described, it will be appreciated by those skilled in the art that various modifications may be made without departing from the scope of the present invention, which is intended to be limited solely by the appended claims.

What is claimed is:

1. A capacitive whiteboard eraser, comprising:
an eraser body, for the user to hold the capacitive whiteboard eraser with hand;
a control circuit board, disposed in the eraser body and configured to generate a erasing control signal;
an emitting electrode, disposed in a housing of the eraser body, electrically connected with the control circuit board, and configured to transmit the erasing control signal; and
a tact switch, disposed on the control circuit board, wherein when the tact switch is turned on, the control circuit board correspondingly generates and transmits the erasing control signal to the emitter electrode, in order to transmit the erasing control signal to a capacitive whiteboard for performing an erasing procedure.

2. The capacitive whiteboard eraser of claim 1, wherein the emitting electrode further comprises a connecting member, and the emitting electrode is electrically connected the control circuit board by the connecting member.

3. The capacitive whiteboard eraser of claim 1, further comprising a triggering member, and when the capacitive whiteboard eraser erases on an electrical whiteboard, the triggering member electrically connects the tact switch, so as to turn on the tact switch.

4. The capacitive whiteboard eraser of claim 3, wherein the emitting electrode is disposed on a bottom housing of the eraser body, and the tact switch is disposed on a bottom side of the control circuit board, and the triggering member is disposed on a top side of the bottom housing and facing the tact switch.

5. The capacitive whiteboard eraser of claim 4, wherein when the capacitive whiteboard eraser erases on the electrical whiteboard, the bottom housing is pressed by the electrical whiteboard so that the triggering member is correspondingly driven to move towards an inside of the eraser body, and therefore the triggering member is electrically connected with the tact switch so as to turn on the tact switch.

6. The capacitive whiteboard eraser of claim 4, wherein when the capacitive whiteboard eraser moves away from the electrical whiteboard, the bottom housing causes the triggering member to be reset to an original position, so that the triggering member and the tact switch are not electrically connected in order to turn off the tact switch.

7. The capacitive whiteboard eraser of claim 4, wherein a left side housing and a right side housing of the eraser body are combined to form a slot, and a connecting part of the triggering member is disposed in the slot.

8. The capacitive whiteboard eraser of claim 7, wherein the eraser body comprises a resetting member disposed in the slot, and the resetting member is disposed between the connecting part of the triggering member and a side wall of the slot.

9. The capacitive whiteboard eraser of claim 3, wherein the emitting electrode is disposed on a top housing of the eraser body, and the tact switch is disposed on a top side of the control circuit board, and the triggering member is disposed on a bottom side of the top housing of the eraser body and facing the tact switch.

10. The capacitive whiteboard eraser of claim 9, wherein when the capacitive whiteboard eraser erases on the electrical whiteboard, the top housing of the eraser body pressed by the electrical whiteboard so that the triggering member correspondingly is driven to move towards an inside of the eraser body, and therefore the triggering member and the tact switch are electrically connected with each other to turn on the tact switch.

11. The capacitive whiteboard eraser of claim 9, wherein when the capacitive whiteboard eraser moves away from the electrical whiteboard, the top housing of the eraser body causes the triggering member to be reset to the original position, so that the triggering member and the tact switch are not electrically connected in order to turn off the tact switch.

12. The capacitive whiteboard eraser of claim 9, wherein a left side housing and a right side housing of the eraser body are combined to form a slot, and a connecting part of the triggering member is disposed in the slot.

13. The capacitive whiteboard eraser of claim 12, wherein the eraser body comprises a resetting member disposed in the slot, and the resetting member is disposed between the connecting part of the triggering member and a side wall of the slot.

14. The capacitive whiteboard eraser of claim 1, wherein the eraser body comprises a left side housing, a right side housing, a top housing and a bottom housing, and any two or three housings of said left side housing, said right side housing, said top housing and said bottom housing are integrated as one member, or all of said left side housing, said right side housing, said top housing and said bottom housing are independent member.

15. The capacitive whiteboard eraser of claim 14, wherein both of said left side housing and said right side housing have a holding member outside said left side housing and said right side housing for the user to take and use said capacitive whiteboard eraser with hand conveniently.

16. The capacitive whiteboard eraser of claim 15, wherein the bottom housing has a circular bottom, and the triggering member comprises an accommodating cavity for accommodating the emitting electrode.

17. The capacitive whiteboard eraser of claim 16, wherein the emitting electrode is disposed at the center region of the accommodating cavity and disposed on the bottom housing.

18. The capacitive whiteboard eraser of claim 14, wherein the capacitive whiteboard eraser has a low power indicator deposed on said top housing or in said top housing for giving an alarm when the power of a battery is low.

19. The capacitive whiteboard eraser of claim 18, wherein the control circuit board comprises a detecting circuit, configured to detect the state of voltage of said battery or the state of charge of said battery, and then the detecting circuit notifies said low power indicator to give an alarm when the voltage or the charge of said battery is in low state.

20. The capacitive whiteboard eraser of claim 17, wherein the capacitive whiteboard eraser defines a position of the emitting electrode as a center, and adopt a predefined diameter or radius to be the diameter or the radius of the erasing area of the capacitive whiteboard eraser.
